(19) United States
(12) Patent Application Publication
(10) Pub. No.: US 2015/0249290 A1
(43) Pub. Date: Sep. 3, 2015

(54) SLOT FED DIPOLE ANTENNA

(71) Applicant: Molex Incorporated, Lisle, IL (US)

(72) Inventors: Finn Hausager, Aalborg (DK); Ole JAGIELSKI, Frederikshavn (DK); Morten CHRISTENSEN, Aalborg (DK); Simon SVENDSEN, Aalborg (DK)

(73) Assignee: Molex Incorporated, Lisle, IL (US)

(21) Appl. No.: 14/419,143

(22) PCT Filed: Jul. 31, 2013
(86) PCT No.: PCT/US2013/052879

§ 371 Date: Feb. 2, 2015

Related U.S. Application Data
(60) Provisional application No. 61/677,680, filed on Jul. 31, 2012.

(51) Int. Cl. H01Q 9/26; H01Q 1/48

(52) U.S. Cl. CPC H01Q 9/26; H01Q 1/48

(57) ABSTRACT

A dipole antenna system is disclosed. An indirect feed technique is used to feed the antenna and the radiating elements are connected to a shield of a coax cable. The balanced termination allows for improved bandwidth compared to conventional dipole antenna configuration and helps manage current on the shield of the coax cable.

### RELATED APPLICATIONS

This application claims priority to U.S. Provisional Application No. 61/677,680, filed Jul. 31, 2012, which is incorporated herein by reference in its entirety.

### FIELD OF THE INVENTION

The present invention relates to field of antennas, more specifically to the field of dipole antennas.

### DESCRIPTION OF RELATED ART

Dipole antennas and their performance are known. In portable device applications, it is common to connect to an antenna with a coax cable, which includes an inner conductor and an outer shield. One issue with dipole antennas is that when they are connected to a coax cable there tends to be an undesirable amount of current on the shield of the coax cable. Baluns and chokes are traditional techniques used to minimize the cable effect on antenna designs. The balun transforms an unbalanced feed into a balanced feed, whereby ideally no currents will flow on the outside of the cable. Chokes increases the impedance on the outside of the coax cable shield, which will prevent current flowing on the coax cable shield. Traditional baluns and chokes for antenna designs requires additional volume, ferrite core transformers and/or discrete components (see FIGS. 1A-1D, which are depictions from Antenna Theory: Analysis and Design by Constanitine A. Balanis) and such solutions are not preferable for many wireless applications, where size, price and simplicity of the antenna is important.

The length of a typical λ/4 balun (FIGS. 2A and 2B) is approximately 8.3 cm at 900 MHz and to get the best performance it should be perpendicular to the radiation structure. As can be appreciated, such a configuration results in a significant increase in the overall volume of the antenna. Therefore, such configurations are less flexible in terms of implementation into wireless consumer products. In addition, ferrite core baluns/chokes are lossy and increase the overall cost and size of the antenna. Due to the relative complicated implementation that would be required, none of the baluns and chokes shown in FIGS. 1A-1D are suited for mass production.

### BRIEF SUMMARY

An embodiment includes a high impedance slot fed dipole (HISF-D) antenna connected to a coax cable. The inner conductor of the coax cable is connected to a coupler that is indirectly coupled to a radiating element. The radiating element includes two dipole arms that connect to the shield of the cable, allowing for balanced termination and reduced current on the shield of the coax cable. The dipole arms can be connected to the shield via inductors to adjust the response of the radiating element.

In another embodiment, a low impedance slot fed antenna dipole (LISF-D) antenna can be provided. The inner conductor of the coax cable is connected to a coupler that is connected to ground and couples to a radiating element. The radiating element includes two dipole arms that couple directly to the shield of the coax cable, allowing for reduced current on the shield. The depicted designs can help reduce the impact of the feed cable on the antenna system while provide improvements in bandwidth compared to conventional dipole antennas.

### BRIEF DESCRIPTION OF THE DRAWINGS

The present invention is illustrated by way of example and not limited in the accompanying figures in which like reference numerals indicate similar elements and in which:

FIGS. 1A-1D illustrate known prior art balum and choke designs that can used with antennas.

FIG. 2A illustrates a traditional dipole antenna.

FIG. 2B illustrates an embodiment of a high impedance slot fed dipole (HISF-D) antenna.

FIG. 3A illustrates the matched impedance of the antenna configuration depicted in FIG. 2A.

FIG. 3B illustrates the matched impedance of the antenna configuration depicted in FIG. 2B.

FIG. 4 illustrates another embodiment of a HISF-D antenna.

FIG. 5 illustrates the matched impedance of the antenna configuration depicted in FIG. 4.

FIG. 6 illustrates an embodiment of a HISF-D antenna connected to a coax cable.

FIG. 7A illustrates a model of a convention dipole antenna.

FIG. 7B illustrates a model of a HISF-D antenna.

FIG. 7C illustrates the current flow of the model depicted in FIG. 7A.

FIG. 7D illustrates the current flow of the model depicted in FIG. 7B.

FIG. 8 illustrates an embodiment of a low impedance slot fed dipole (LISF-D) antenna.

FIG. 9 illustrates the matched impedance of the antenna configuration depicted in FIG. 8.

FIG. 10 illustrates another embodiment of a LISF-D antenna.

FIG. 11 illustrates the matched impedance of the antenna configuration depicted in FIG. 10.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

The following description describes novel techniques for feeding and matching a standard dipole antenna. One potential advantage of the techniques discussed is that the impedance bandwidth can be increased by a factor of more than 2 while that the feed is balanced, so that the effects of the cable can be reduced. Embodiments below include the high impedance slot fed dipole (HISF-D) antennas and a low impedance slot fed dipole (LISF-D), which are naturally balanced structures. The HISF and LISF slot feeding technique increase the impedance bandwidth, without increasing the antenna volume or decreasing the total efficiency.

It should be noted that when discussing a coax cable, it is assumed that the coax cable includes an inner conductor, a first insulative layer surrounding the inner conductor, a shield layer surrounding the first insulative layer, and then a second insulative layer surrounding the shield. While additional layers can be added, the above is a standard coax cable construction and thus well known to persons of skill in the art.

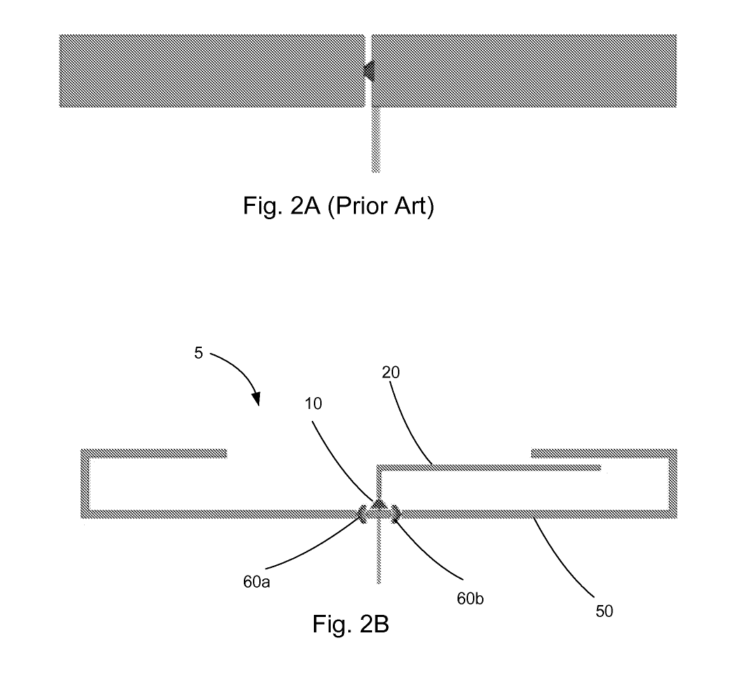

The HISF-D is based on the indirect feed techniques described PCT Application No. PCT/US2010/047978, filed Sep. 7, 2010, which is incorporated herein by reference in its entirety, however as used herein the indirect feeding technique is used to create a fully balanced feed of the dipole. An example of the HISF-D implementation is shown in FIG. 2B in conjunction with a traditional dipole radiating elements. A feed 10 is connected to a coupler 20, which indirectly couples to the radiating element 50 (which is in a dipole configuration). Inductors 60a, 60b are used to tune the antenna. The area of the two antennas (78 mm×9 mm) used in these examples has been optimized for size, therefore inductors are used to tune the resonance frequency to 900 MHz. The concepts described in this disclosure are also valid for self-resonating dipoles, where the inductors can be avoided.

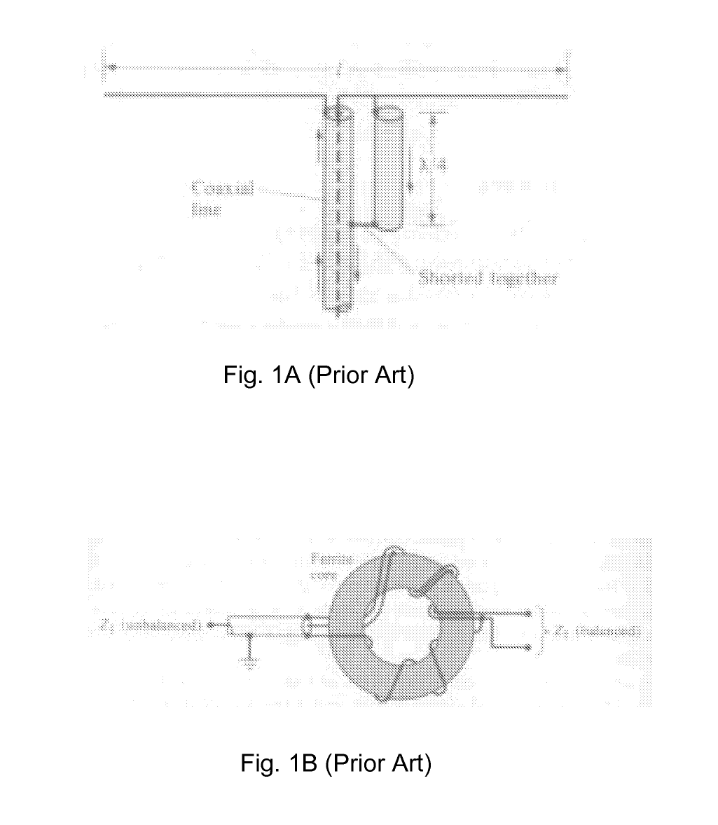

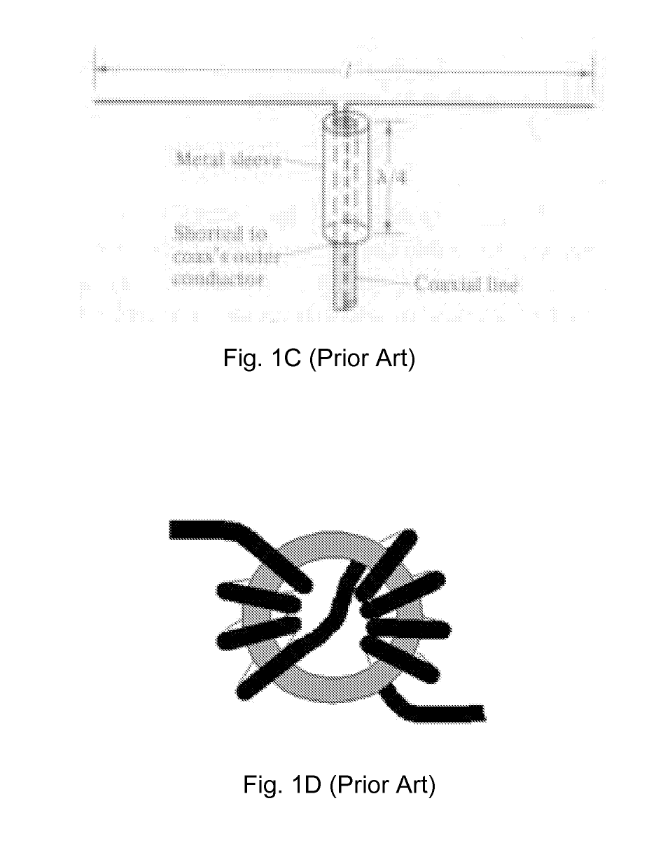

The traditional dipole fed with a coax cable is inherently unbalanced, since the coupling between the inner conductor and the shield (the two radiating parts of the dipole) are very weak, whereby the current flow on the ground arm will be much higher than on the feed arm, which will result in current flowing down the outside of the coax cable. The bazooka balun shown in FIG. 1C chokes the current flowing down the coax cable by electrically creating a high impedance point where the ground arm is connected to the coax shield. The baluns shown in FIGS. 1A and 1B, increases the coupling between the 2 dipole arms, without cancelling the radiation, whereby the magnitude of the currents flowing on the inner conductor and on the inside of the coax shield can equalized, thus canceling the current flowing on the outside the coax shield.

The HISF-D antenna depicted in FIG. 2B has both of the dipole arms connected directly to the shield of the coax cable and at a symmetrical point. This results in a high coupling between the two arms of the dipole and current flow on both radiating arms, whereby the current on the outside of the coax cable will be insignificant. The signal is indirectly fed to one of the dipole arms, exciting the signal onto the radiating structure.

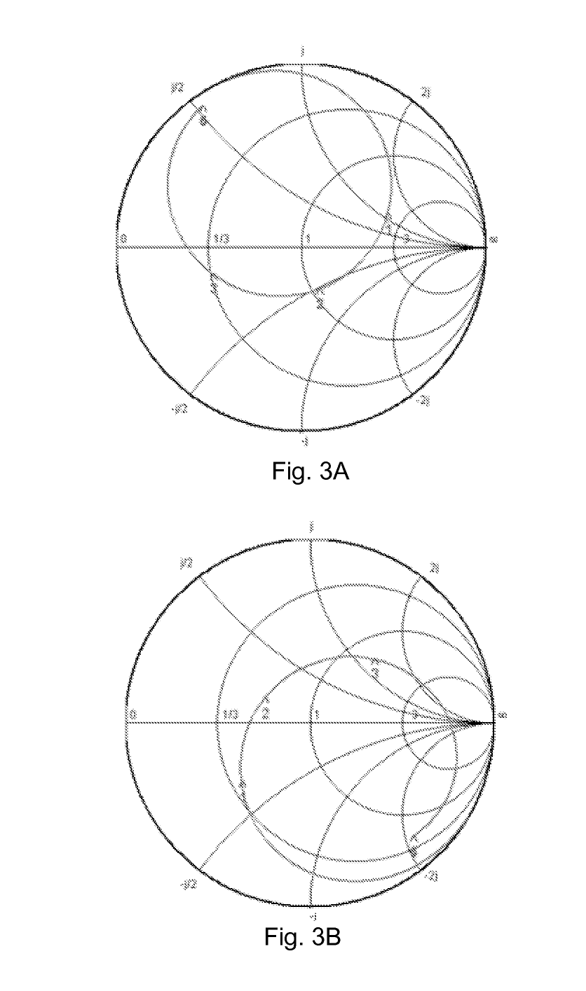

The matched impedances of the traditional dipole (FIG. 2A) and the HISF-D, illustrated in FIG. 2B, are shown in FIGS. 3A and 3B. Two ideal inductors have been used to match both of the antennas. These components can be replaced by using meanderings and/or slots in the antenna pattern.

As can be appreciated, with the HISF-D antenna a balanced feeding has been obtained without an increase in antenna volume. The obtained impedance bandwidth for the HISF-D used in this example is approximately 35% less than that obtained be the traditional dipole. This reduction in impedance bandwidth is due to the high coupling between the indirect feed and one of the radiating arms.

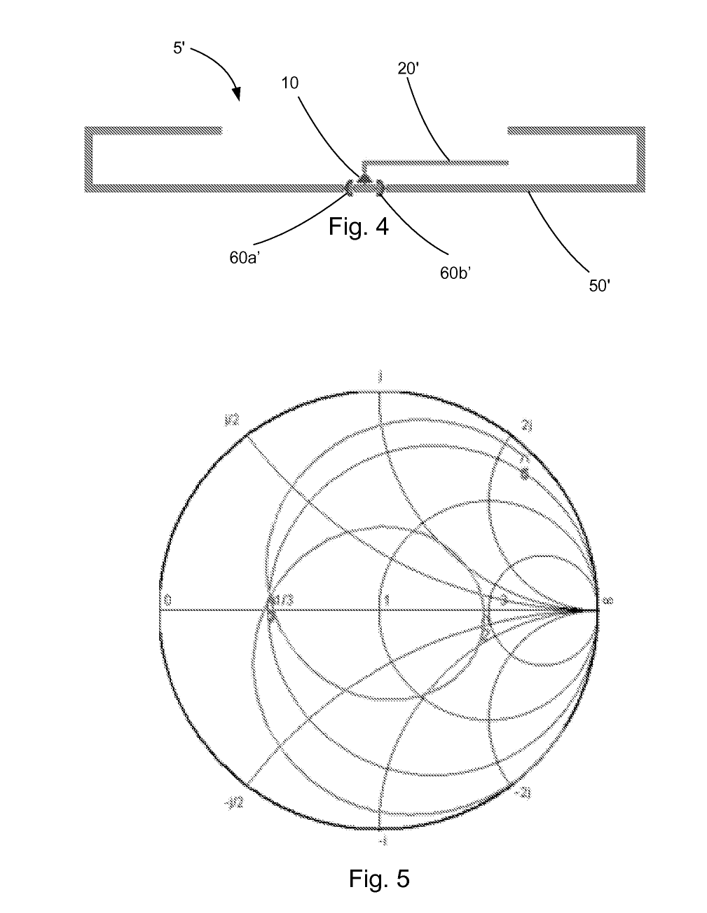

The impedance bandwidth of antenna 5 can be significantly improved by reducing the coupling from the high impedance slot feed (e.g., by reducing the indirect coupling between the coupler and the radiating element) and add more series inductance to the feed, as illustrated by antenna 5′ in FIG. 4. A feed port 10 is connected to a coupler 20′, which indirectly couples to a radiating element 50′ (which is in a dipole configuration). The needed series inductance can be provided by use discrete inductor (not shown) at the feeding port. Two additional inductors 60a′, 60b′ have been used to tune the resonance frequency to 900 MHz.

The complex impedance of HISF-D is shown in FIG. 5. The second resonance created by the high impedance slot fed configuration is clearly seen as the curl around 50Ω in the smith chart. This increased impedance bandwidth is achieved without degrading the total efficiency of the antenna and without increasing the volume of the antenna, while maintaining the balanced antenna structure in a compact configuration.

The difference in impedance bandwidth is illustrated in Table 1, where the HISF-D depicted in FIG. 4 is compared to the traditional dipole shown in FIG. 2A.

TABLE 1

| | Bandwidth Frequencies at SWR = 3 | | | |
|---|---|---|---|---|
| | Start | Stop | Bandwidth | Bandwidth |
| High impedance slot feed | 851 MHz | 969 MHz | 118 MHz | 13.0% |
| Standard direct feed | 877 MHz | 928 MHz | 51 MHz | 5.7% |
| Improvement | | | 67 MHz | 128% |

As can be appreciated, the impedance bandwidth of an antenna with the HISF-D solution is more than two times the bandwidth of a tradition dipole antenna system.

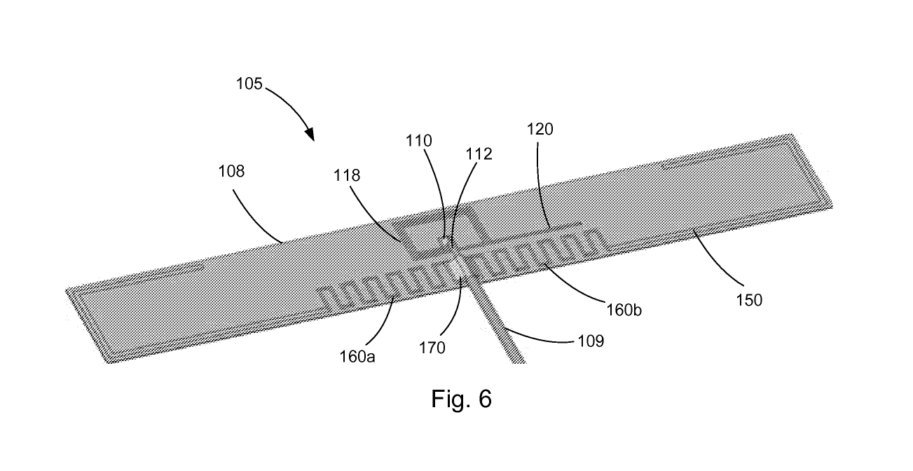

The embodiment depicted in FIG. 4 includes discrete components for matching, however such a construction is less desirable for mass production as the use of discrete components is likely to result in an increase in the cost of the antenna system. It has been determined that these components can be removed by using meandering to adjust the resonance frequency of the antenna and increase the series inductance in the antenna feeding structure to match it to 50Ω, and an embodiment of this is depicted in FIG. 6.

The embodiment depicted in FIG. 6 is designed for an antenna 105 that includes single layer flex PCB 108 (although multi-layer configurations are also suitable) connected to a coax cable 109 in order keep the production complexity down and reduce the overall cost of the antenna 105. A conductor 112 provided in the coax cable 109 is connected via the feed 110 to a series inductor 118. The series inductor 118 (which is provided by looping the trace) is used to match feed 110 of the antenna to 50Ω, however this could also have been achieved by increasing the phase delay in the indirect feed and use a parallel inductor instead. The series inductor 118 is connected to a coupler 120. The coupler 120 indirectly couples to the radiating element 150 in a manner similar to that discussed in PCT Application No. PCT/US2010/047978, filed Sep. 7, 2010. Meandering inductors 160a, 160b use connection 170 to connect to ground (which is provided by the shield in the coax cable 110) so to provide a balanced termination that minimizes current flow on the shield.

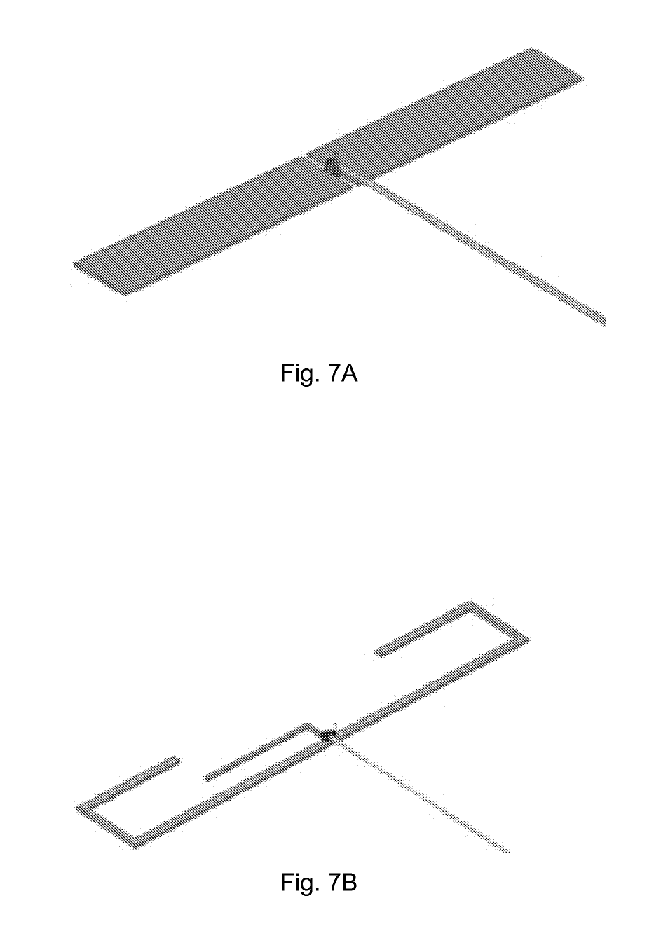

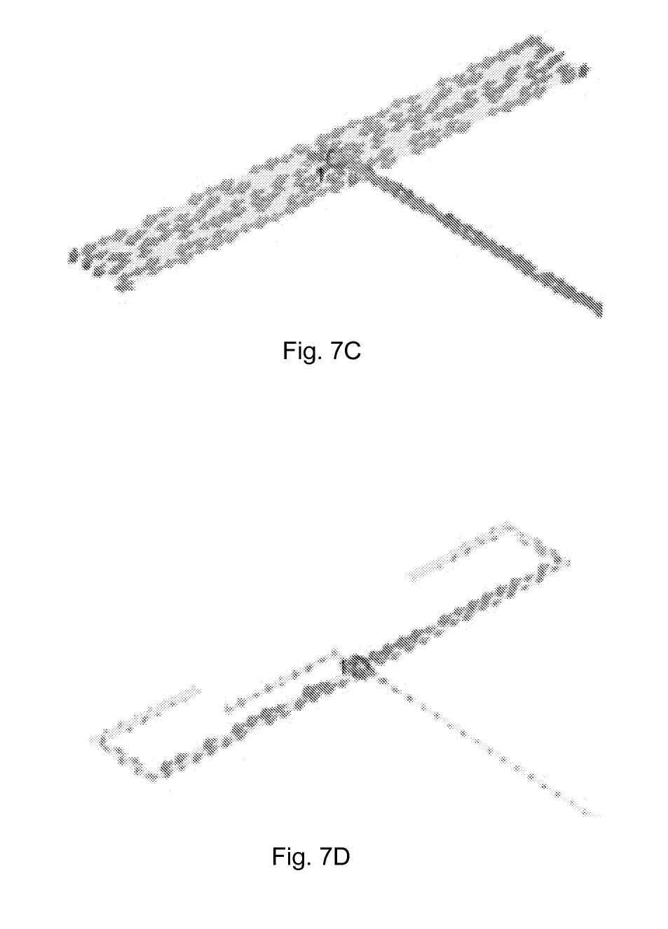

A design of a traditional dipole (FIG. 7A) and a HISF-D (FIG. 7B) have been simulated including a 100 mm cable to illustrate the surface current flow on the structures. The surface current plots in FIG. 7C is for the traditional dipole depicted in FIG. 7A and the surface current plot in FIG. 7D is for the HISF-D design depicted in FIG. 7B and these plots show that the current flowing on the cable is significantly smaller on the HISF-D antenna design compared to the traditional dipole antenna design.

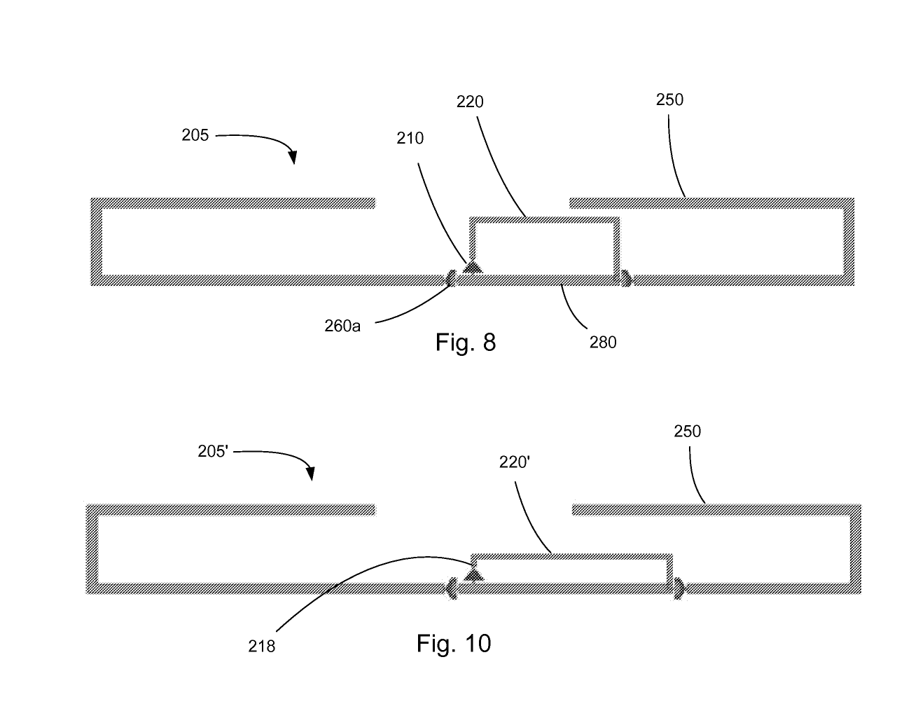

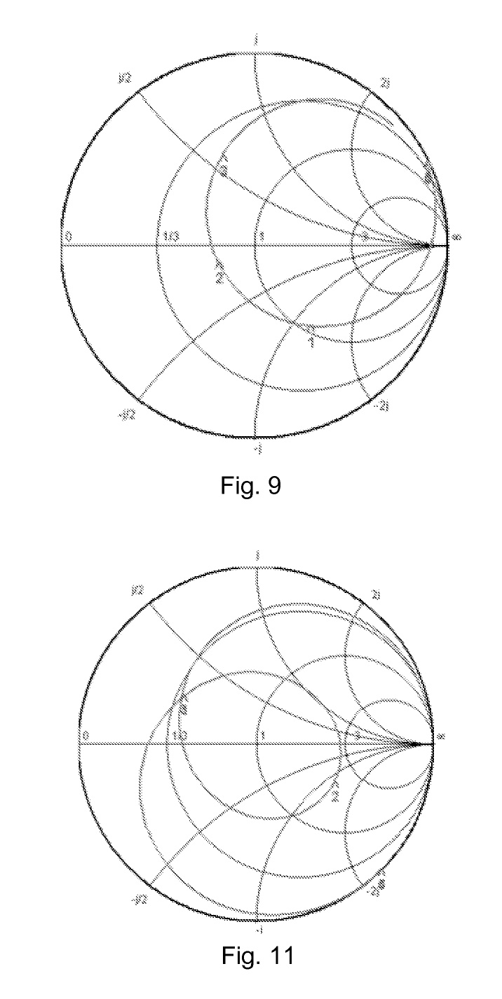

The low impedance slot feed technique described in PCT Application No. PCT/US2010/047978, filed Sep. 7, 2010 (discussed above) can also be used to obtain a balanced dipole with improved impedance bandwidth. An example of a LISF-D is shown in FIG. 8. An antenna 205 includes a feed 210 connected to a coupler 220 that is connected to ground 280. The coupler 220 indirectly couples to radiating element 250, which can include inductors such as inductor 260a to provide the desired tuning of the radiating element. The matched impedance of the LISF-D is shown in FIG. 9.

The initial impedance bandwidth of this LISF-D is in the same range as that obtained by the traditional dipole antenna (depicted in FIG. 2A). However, the impedance can be further improved by increasing the coupling and adding a series capacitor to the match. FIG. 10 illustrates an enhanced embodiment of the LISF-D antenna and includes a series conductor 218. The series match capacitor can be implemented as part of the antenna structure on, for example a double-sided Flex PCB.

The matched impedance of the self-matched LISF-D with improved impedance bandwidth is illustrated in FIG. 11. The second resonance created by the low impedance slot fed is clearly seen as the curl around 50Ω in the smith chart. This increased impedance bandwidth is achieved without degrading the total efficiency of the antenna and without increasing the volume of the antenna, while maintaining the balanced antenna structure.

The difference in impedance bandwidth is illustrated in Table 2, where the LISF-D is compared to the traditional dipole shown in FIG. 2A:

TABLE 2

| | Bandwidth Frequencies at SWR = 3 | | | |
|---|---|---|---|---|
| | Start | Stop | Bandwidth | Bandwidth |
| Low impedance slot feed | 852 MHz | 957 MHz | 104 MHz | 11.4% |
| Standard direct feed | 877 MHz | 928 MHz | 51 MHz | 5.7% |
| Improvement | | | 53 MHz | 104% |

The LISF-D provides more than twice the impedance bandwidth of a tradition dipole. The example shown in FIG. 9 uses a series capacitor to match the antenna impedance to 50Ω. It should be noted that the match can also be achieved by decreasing the phase delay in the indirect feed (e.g., by using a parallel capacitor).

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. An antenna system, comprising:
a coax cable with a center conductor and a conductive shield;
a feed connected to center conductor;
a coupler connected to the feed;
a radiating element in a dipole configuration, the radiating element indirectly coupled to the coupler, wherein the radiating element is connected to the conductive shield.

2. The antenna system of claim 1, wherein the coupler is connected to ground.

3. The antenna system of claim 1, wherein the coupler is not connected to ground.

4. The antenna system of claim 1, wherein the radiating element includes inductors positioned between the radiating element and the conductive shield.

5. The antenna system of claim 4, wherein the inductors are positioned on two sides of the conductive shield so as to provide a balanced termination from the radiating element to the conductive shield.

6. The antenna system of claim 1, wherein the coupler and the radiating element are provided as traces on a flexible circuit board and the coax cable is mounted to the flexible circuit board.

7. The antenna system of claim 6, wherein a meandering path is provided between the feed and the coupler so as to provide an inductor in series between the feed and the coupler.

8. The antenna system of claim 6, wherein a meandering path is provided between the radiating element and the conductive shield, the meandering path configured to act as an inductor and tune the response of the radiating element.
